(19) United States
(12) Patent Application Publication
(10) Pub. No.: US 2006/0000783 A1
(43) Pub. Date: Jan. 5, 2006

(54) Use of chitosan as a clarification aid for mining ponds

(76) Inventors: Merle L. Branning, Plano, IL (US); Stephen J. Blubaugh, Naperville, IL (US); John A. Lansdale, Tampa, FL (US); David R. Macedon, Lemont, IL (US)

Correspondence Address: NALCO COMPANY, 1601 W. DIEHL ROAD, NAPERVILLE, IL, 60563-1198, US

(21) Appl. No.: 10/880,635

(22) Filed: Jun. 30, 2004

(51) Int. Cl. C02F 1/52

(52) U.S. Cl. 210/730

(57) ABSTRACT

A method of clarifying a slurry in a mining pond is described and claimed. The slurry contains water and mined solids. The method uses chitosan, optionally formulated with an inert fluorescent tracer, to clarify the slurry in a mining pond. This clarification process causes mined solids to settle to the bottom of the pond leaving the water less turbid than before the application of chitosan.

### FIELD OF THE INVENTION

This invention is in the field of mining and mineral processing. More particularly this invention concerns the use of chitosan as a clarification aid for mining ponds, where the ponds contain a slurry, and the slurry comprises water and mined solids.

### BACKGROUND OF THE INVENTION

At mines and mined solids processing plants, ponds are used to hold a slurry wherein the slurry comprises water and mined solids. For purposes of this patent application, “mined solids” are defined as any material removed from its original location on or in the ground. Thus mined solids can contain the target material for the mine, such as coal, gold, silver, iron ore, bauxite and potassium chloride, and mined solids typically also contain unwanted rocks, soil and other materials, such as wood and leaves and grass.

Currently, polymers are added to mining ponds containing a slurry, wherein the slurry comprises water and mined solids. The polymers act to agglomerate mined solids to increase their likelihood for settling. Thus, the polymers help clarify the slurry such that the mined solids are separated from the water. The water may then be taken from the pond for either later use or for addition to a natural body of water. Known polymers that are useful to clarify mining ponds, include poly diallyldimethyl ammonium chloride (DADMAC), epichlorohydrin dimethylacrylate (EPI/DMA), polyaluminum chloride/calcium chloride (PAC/CaCl₂) and the like.

It would be desirable to identify additional materials that are capable of functioning as clarification aids for mining ponds containing a slurry wherein the slurry comprises water and mined solids.

### SUMMARY OF THE INVENTION

The first aspect of the instant claimed invention is a method of clarifying a slurry in a mining pond, wherein the slurry comprises water and mined solids, comprising
a) adding to the slurry from about 0.01 lbs chitosan/ton dry solids in the water in the pond to about 100 lbs chitosan/ton dry solids in the water in the pond, and
b) allowing the chitosan to clarify the slurry with the result being that the mined solids are substantially separated from the water in the pond.

The second aspect of the instant claimed invention is the method of the first aspect of the instant claimed invention wherein an inert fluorescent tracer is added to the chitosan and one or more fluorometers are used to detect the fluorescent signal of the inert fluorescent tracer in the slurry in the pond, which fluorescent signal is used to determine how much inert fluorescent tracer is present and that information is used to determine how much chitosan is present and by knowing how much chitosan is present then if desired, adjustments to the operating conditions of the mining pond can be made to ensure the desired amount of chitosan is present.

### DETAILED DESCRIPTION OF THE INVENTION

Throughout this patent application, the following terms have the indicated meanings.

“Coal” means a natural, solid, combustible material formed from prehistoric plant life which occurs in layers or veins in sedimentary rocks. Chemically, coal is a macromolecular network composed of groups of polynuclear aromatic rings, to which are attached subordinate rings connected to oxygen, sulfur and aliphatic bridges.

“Bauxite” is a naturally occurring, heterogeneous material composed primarily of one or more aluminum hydroxide minerals, plus various mixtures of silica, iron oxide, titania, aluminosilicate and other impurities in minor or trace elements. Bauxite is also known as “aluminum ore”.

“Gold” is a precious metal usually mined and processed with silver. Gold is a ductile, malleable opaque lustrous “butter” yellow metal made up of isometric crystals. Gold has a hardness of 2.5-3 and a specific gravity of about 19.3.

“Iron ore” is a mineral substance which, when heated in the presence of a reductant, will yield metallic iron (Fe) which is used in steel manufacturing.

“LC₅₀” is that concentration of a material in water that will be lethal to 50% of the test subjects when administered as a single exposure over a set, typically about 1 to 4 hours, time period. LC₅₀ information always has to be reported in units of mass per volume of water and also has to be reported relative to a specific test subject

“Nalco” means Nalco Company, 1601 W. Diehl Road, Naperville, Ill. 60563. (630) 305-1000.

Natural Site Solutions refers to Natural Site Solutions, 6213 East Lake Sammamish Parkway Northeast, Redmond, Wash. 98052, Telephone number (425) 861 9499.

“Potassium chloride” is mined from sylvite deposits in New Mexico and Saskatchewan and then purified by fractional crystallization or flotation.

“Silver” is a precious metal usually mined and processed with gold. Silver is a lustrous, white, malleable and ductile metal, with remarkably useful electrical and thermal and light reflecting and bacteria killing and wear resistant and photosensitive properties.

“Ton” is 2000 pounds.

“Vanson/HaloSource” refers to Vanson Halo Source, 14716 NE 87th Street, Redmond, Wash. 98052, Telephone (425) 881 6464.

The instant claimed invention is a method of clarifying a slurry in a mining pond, wherein the slurry comprises water and mined solids, comprising
a) adding to the slurry from about 0.01 lbs chitosan/ton dry solids in the water in the pond to about 100 lbs chitosan/ton dry solids in the water in the pond, and
b) allowing the chitosan to clarify the slurry with the result being that the mined solids are substantially separated from the water in the pond.

Mining ponds are used to hold slurries comprising water and mined solids. Mining ponds can be formed out of naturally occurring bodies of water or they can be constructed on an “as needed” basis to process slurries comprising water and mined solids. The mining ponds formed out of naturally occurring bodies of water typically have natural water sources, such as rain water or runoff from rain, to replenish the water in the pond. The constructed mining ponds typically have slurries comprising water and mined solids pumped to the pond, from the mine or mined solids processing plant.

Mined solids are defined herein as any material removed from its original location on or in the ground. Thus mined solids can contain the target product for the mine, such as coal, gold, silver, iron ore, bauxite and potassium chloride, and mined solids typically also contain unwanted rocks and soil and other materials, such as wood and leaves and grass. Mined solids can be transported with water to mining ponds at the mine itself. Also, mined solids can be transported with water to mining ponds at the mined solids processing plant.

For the instant claimed invention, the preferred mining ponds are at coal mines and coal processing plants.

Chitosan is a natural polysaccharide of poly-D-glucosamine, which is also described chemically as a deacylated derivative of chitin. Chitin is the principal constituent of the shells of crabs, lobsters and beetles.

Chitosan has the formula C₆H₁₁NO₄, and each Chitosan “unit” has a molecular weight of 161 atomic mass units (hereinafter “a.m.u.”). Chitosan polymers typically have a molecular weight of between about 3000 a.m.u. and about 300,000 a.m.u.

Chitosan can be made in liquid, dry (including dry tablets) and gelatinous forms.

Chitosan is available commercially from a variety of different chemical supply companies. Some, but by no means all, commercial chitosan products include the following:

Storm-Klear Gel-Floc™, a chitosan/lactic acid polymer, about 50% actives, available from Natural Site Solutions.

Liqui-Floc™, a chitosan polymer, about 1% actives, available from Natural Site Solutions.

Klarify 101 Solution, a chitosan/lactic acid polymer, about 1% actives, available from Vanson/Halosource Corporation.

Klarify 201, a chitosan polymer, about 2% actives, available from Vanson/Halosource Corporation.

ChitoSolv L also known as Chitosan lactate, which is about 65% chitosan and about 35% lactic acid, available in a powder form, about 100% actives, available from Vanson/Halosource Corporation.

It should be appreciated that this list of commercial Chitosan products is not comprehensive. Other commercially available Chitosan products and modifications thereof can also be used in the method of this invention.

The amount of Chitosan added to the water is from about 0.01 lbs chitosan/ton dry solids in the water in the pond to about 100 lbs chitosan/ton dry solids in the water in the pond. Preferably the amount of Chitosan added to the water is from about 0.01 lbs chitosan/ton dry solids in the water in the pond to about 10 lbs chitosan/ton dry solids in the water in the pond. Most preferably the amount of Chitosan added to the water is from about 0.01 lbs chitosan/ton dry solids in the water in the pond to about 1 lbs chitosan/ton dry solids in the water in the pond.

The method of dosage of the chitosan can enhance the efficacy of the chitosan in clarifying the slurry comprising water and mined solids. A relatively slow addition and dissolution rate is favored over a relatively rapid, “shock” contact of the slurry with the chitosan. Therefore, use of means for controlled addition of the chitosan to the slurry in the mining pond is recommended. For those mined ponds where the source of the water is natural water, such as rain and runoff from rain, the means include commercially available bait buckets and media socks and any other commercially available means for slow delivery of a natural polymer to an aqueous system. It has been discovered that placing a “bait bucket” or “media sock”, of chitosan, within the natural water feed stream to the mining pond, is a preferred technique for addition of the chitosan to the water. These bait buckets and media socks are available from materials handling equipment companies.

The means for addition of chitosan to constructed mining ponds can include pumps and pipes wherein the flow rate of chitosan is adjusted by the flow rate of the pump and flow meters.

The clarified water from a mining pond can either be returned to the mine or to the mining processing plant for further use. Or the clarified water can end up being discharged into a natural body of water. Chitosan has been reported to have an LC₅₀ for Daphnia of 463 mg/L and a LC₅₀ for Rainbow Trout of 155 mg/L. These LC₅₀ results indicate that chitosan has been found to be of relative low toxicity to aquatic organisms. This is an especially valuable feature of the instant claimed invention in those instances where the chitosan travels with the clarified water into a natural body of water, rather than settling with the mined solids.

The second aspect of the instant claimed invention is the method of the first aspect of the instant claimed invention wherein an inert fluorescent tracer is added to the chitosan and one or more fluorometers are used to detect the fluorescent signal of the inert fluorescent tracer in the slurry in the pond, which fluorescent signal is used to determine how much inert fluorescent tracer is present and that information is used to determine how much chitosan is present and by knowing how much chitosan is present then if desired, adjustments to the operating conditions of the mining pond can be made to ensure the desired amount of chitosan is present.

“Inert fluorescent tracer compound” means a material which is capable of fluorescing while present in the water in the mining pond that is being treated with chitosan. The inert fluorescent tracer compound should not be appreciably affected by any other material present in the water of the mining pond, or by the temperature or temperature changes encountered in the mining pond.

Inert fluorescent tracers suitable for use with chitosan are selected from the group comprising:
1-deoxy-1-(3,4-dihydro-7,8-dimethyl-2,4-dioxobenzo[g]pteridin-10(2H)-yl)-D-ribitol, also known as Riboflavin or Vitamin B2 (CAS Registry No. 83-88-5),
fluorescein (CAS Registry No. 2321-07-5),
fluorescein, sodium salt (CAS Registry No. 518-47-8, aka Acid Yellow 73, Uranine),
2-anthracenesulfonic acid sodium salt (CAS Registry No. 16106-40-4),
1,5-anthracenedisulfonic acid (CAS Registry No. 61736-91-2) and salts thereof,
2,6-anthracenedisulfonic acid (CAS Registry No. 61736-95-6) and salts thereof,
1,8-anthracenedisulfonic acid (CAS Registry No. 61736-92-3) and salts thereof,
mono-, di-, or tri-sulfonated napthalenes, including but not limited to
1,5-naphthalenedisulfonic acid, disodium salt (hydrate) (CAS Registry No. 1655-29-4, aka 1,5-NDSA hydrate),
2-amino-1-naphthalenesulfonic acid (CAS Registry No. 81-16-3),
5-amino-2-naphthalenesulfonic acid (CAS Registry No. 119-79-9),
4-amino-3-hydroxy-1-naphthalenesulfonic acid (CAS Registry No. 90-51-7),
6-amino-4-hydroxy-2-naphthalenesulfonic acid (CAS Registry No. 116-63-2),
7-amino-1,3-naphthalenesulfonic acid, potassium salt (CAS Registry No. 79873-35-1),
4-amino-5-hydroxy-2,7-naphthalenedisulfonic acid (CAS Registry No. 90-20-0),
5-dimethylamino-1-naphthalenesulfonic acid (CAS Registry No. 4272-77-9),
1-amino-4-naphthalene sulfonic acid (CAS Registry No. 84-86-6),
1-amino-7-naphthalene sulfonic acid (CAS Registry No. 119-28-8), and
2,6-naphthalenedicarboxylic acid, dipotassium salt (CAS Registry No. 2666-06-0),
3,4,9,10-perylenetetracarboxylic acid (CAS Registry No. 81-32-3),
C.I. Fluorescent Brightener 191, also known as, Phorwite CL (CAS Registry No. 12270-53-0),
C.I. Fluorescent Brightener 200, also known as Phorwite BKL (CAS Registry No. 61968-72-7),
benzenesulfonic acid, 2,2′-(1,2-ethenediyl)bis[5-(4-phenyl-2H-1,2,3-triazol-2-yl)-, dipotassium salt, also known as Phorwite BHC 766 (CAS Registry No. 52237-03-3),
benzenesulfonic acid, 5-(2H-naphtho[1,2-d]triazol-2-yl)-2-(2-phenylethenyl)-, sodium salt, also known as Pylaklor White S-15A (CAS Registry No. 6416-68-8),
1,3,6,8-pyrenetetrasulfonic acid, tetrasodium salt (CAS Registry No. 59572-10-0),
pyranine, (CAS Registry No. 6358-69-6, aka 8-hydroxy-1,3,6-pyrenetrisulfonic acid, trisodium salt),
quinoline (CAS Registry No. 91-22-5),
3H-phenoxazin-3-one, 7-hydroxy-, 10-oxide, also known as Rhodalux (CAS Registry No. 550-82-3),
xanthylium, 9-(2,4-dicarboxyphenyl)-3,6-bis(diethylamino)-, chloride, disodium salt, also known as Rhodamine WT (CAS Registry No. 37299-86-8),
phenazinium, 3,7-diamino-2,8-dimethyl-5-phenyl-, chloride, also known as Safranine 0 (CAS Registry No. 477-73-6),
C.I. Fluorescent Brightener 235, also known as Sandoz CW (CAS Registry No. 56509-06-9),
benzenesulfonic acid, 2,2′-(1,2-ethenediyl)bis[5-[[4-[bis(2-hydroxyethyl)amino]-6-[(4-sulfophenyl)amino]-1,3,5-triazin-2-yl]amino]-, tetrasodium salt, also known as Sandoz CD (CAS Registry No. 16470-24-9, aka Flu. Bright. 220),
benzenesulfonic acid, 2,2′-(1,2-ethenediyl)bis[5-[[4-[(2-hydroxypropyl)amino]-6-(phenylamino)-1,3,5-triazin-2-yl]amino]-, disodium salt, also known as Sandoz TH-40 (CAS Registry No. 32694-95-4),
xanthylium, 3,6-bis(diethylamino)-9-(2,4-disulfophenyl)-, inner salt, sodium salt, also known as Sulforhodamine B (CAS Registry No. 3520-42-1, aka Acid Red 52),
benzenesulfonic acid, 2,2′-(1,2-ethenediyl)bis[5-[[4-[(aminomethyl)(2-hydroxyethyl)amino]-6-(phenylamino)-1,3,5-triazin-2-yl]amino]-, disodium salt, also known as Tinopal 5BM-GX (CAS Registry No. 169762-28-1),
Tinopol DCS (CAS Registry No. 205265-33-4),
benzenesulfonic acid, 2,2′-([1,1′-biphenyl]-4,4′-diyldi-2,1-ethenediyl)bis-, disodium salt, also known as Tinopal CBS-X (CAS Registry No. 27344-41-8),
benzenesulfonic acid, 5-(2H-naphtho[1,2-d]triazol-2-yl)-2-(2-phenylethenyl)-, sodium salt, also known as Tinopal RBS 200, (CAS Registry No. 6416-68-8),
7-benzothiazolesulfonic acid, 2,2′-(1-triazene-1,3-diyldi-4,1-phenylene)bis[6-methyl-, disodium salt, also known as Titan Yellow (CAS Registry No. 1829-00-1, aka Thiazole Yellow G), and
   all ammonium, potassium and sodium salts thereof, and all like agents and suitable mixtures thereof.

The more preferred fluorescent inert tracers of the present invention include 1,3,6,8-pyrenetetrasulfonic acid tetrasodium salt (CAS Registry No. 59572-10-0); 1,5-naphthalenedisulfonic acid disodium salt (hydrate) (CAS Registry No. 1655-29-4, aka 1,5-NDSA hydrate); xanthylium, 9-(2,4-dicarboxyphenyl)-3,6-bis(diethylamino)-, chloride, disodium salt, also known as Rhodamine WT (CAS Registry No. 37299-86-8); 1-deoxy-1-(3,4-dihydro-7,8-dimethyl-2,4-dioxobenzo[g]pteridin-10(2H)-yl)-D-ribitol, also known as Riboflavin or Vitamin B2 (CAS Registry No. 83-88-5); fluorescein (CAS Registry No. 2321-07-5); fluorescein, sodium salt (CAS Registry No. 518-47-8, aka Acid Yellow 73, Uranine); 2-anthracenesulfonic acid sodium salt (CAS Registry No. 16106-40-4); 1,5-anthracenedisulfonic acid (CAS Registry No. 61736-91-2) and salts thereof; 2,6-anthracenedisulfonic acid (CAS Registry No. 61736-95-6) and salts thereof; 1,8-anthracenedisulfonic acid (CAS Registry No. 61736-92-3) and salts thereof; and mixtures thereof. The fluorescent tracers listed above are commercially available from a variety of different chemical supply companies.

The most preferred inert fluorescent tracer compound is 1,3,6,8-pyrenetetrasulfonic acid, sodium salt.

The chitosan/inert fluorescent tracer compound composition is prepared by adding sufficient inert fluorescent tracer to the chitosan, such that the concentration of inert fluorescent tracer in the mining pond is from about 5 ppt to about 1000 ppm, preferably from about 1 ppb to about 50 ppm, more preferably from about 5 ppb to about 50 ppb of inert fluorescent tracer. The preferred amount of inert fluorescent tracer compound added, within this range may be readily determined by one of ordinary skill in the art, taking into consideration the characteristics of the mined solids being treated and the dimensions and flow patterns into, within and out of the mining pond.

One or more fluorometers are used to detect the fluorescent signal of the inert fluorescent tracer in the slurry in the pond. Suitable fluorometers are selected from the group comprising the TRASAR® 3000 fluorometer, the TRASAR® 8000 fluorometer and the TRASAR® XE-2 Controller, which includes a fluorometer with integrated controller, all available from Nalco; the Hitachi F-4500 fluorometer (available from Hitachi through Hitachi Instruments Inc. of San Jose, Calif.); the JOBIN YVON FluoroMax-3 “SPEX” fluorometer (available from JOBIN YVON Inc. of Edison, N.J.); and the Gilford Fluoro-IV spectrophotometer or the SFM 25 (available from Bio-tech Kontron through Research Instruments International of San Diego, Calif.). It should be appreciated that the fluorometer list is not comprehensive and is intended only to show examples of fluorometers. Other commercially available fluorometers and modifications thereof can also be used in this invention.

After the fluorometer has been used to detect the fluorescent signal of the inert fluorescent tracer in the slurry in the pond then the detected fluorescent signal can be converted into the actual concentration of inert fluorescent tracer using graphs that show what the detected fluorescent signal is for a specific amount of a specific inert fluorescent tracer. These graphs are known to people of ordinary skill in the art of fluorometry.

Because the inert fluorescent tracer is added to the mining pond in a known proportion to the chitosan, by detecting the fluorescent signal of the inert fluorescent tracer it is possible to calculate the amount of chitosan present in the mining pond. This enables the operator to determine whether the correct amount of chitosan is present and even to determine where it is present. If desired, adjustments to the operating conditions of the mining pond can be made to ensure the amount of chitosan present is what is supposed to be present.

The method of the second aspect of the instant claimed invention is especially useful in controlling the feed rate of chitosan to constructed mining ponds.

The foregoing may be better understood by reference to the following Examples, which are presented for purposes of illustration and are not intended to limit the scope of this invention.

### EXAMPLES

The following lab test procedure is used for these examples.
1.) Obtain 5-10 gallons of untreated pond feed.
2.) Using an appropriate mixing device mix the pond feed sample to uniformly disperse the solids present. Immediately sample and transfer 500 ml of the sample, 250 ml at a time, using a graduated cylinder, into each of the 600 ml beakers on a gang stirrer. Re-mix the sample prior to filling each cylinder.
3.) Begin rapid mixing at 100 rpm on gang stirrer.
4.) While mixing, add chitosan product at various dosages (add by injection through syringe).
5.) Following all product addition continue rapid mixing (100 rpm) for two (2) minutes. At this point lower the mixing speed to 40 rpm and mix for two (2) minutes to effect floc formation.
6.) Shut mixing off and evaluate the settling (visual) and clarity (using turbidimeter at 15 minutes) properties of the treated slurry.
7.) Continue this procedure to obtain enough data for activity evaluations of the products.
8.) Turbidity, as measured by NTU (nephelometric turbidity units) vs. dosage (lb/ton) data for each mining pond slurry are found in the following examples. The lower the turbidity, the more clarified the water has become.

### Example 1

This example tests a slurry from a mining pond wherein the mined solids within the slurry are mostly sand and gravel.

The pH of the slurry is about 7.0, the slurry is tested at about 1% solids

| Dose | Product 1 | Product 2 |
|---|---|---|
| (lb/ton) | NTU | NTU |
| 4 | 267 | 95 |
| 8 | 19 | 24 |
| 12 | 8 | 16 |
| 16 | 34 | 12 |
| 20 | 69 | 10 |
| 40 | 820 | 71 |

Product 1 is Liqui-Floc ™, about 1% actives.
Product 2 is Klarify 201 about 2% actives.

### Example 2

This example tests a slurry from a mining pond wherein the mined solids within the slurry are mostly coal and attendant rock and dirt.

The pH of the slurry is about 8.3 and the solids in the slurry are at about 3%.

| Dose of Chitosan | |
|---|---|
| (lb/ton) | Product 1 |
| 0.7 | 360 |
| 1.3 | 8 |
| 2.7 | 7 |

Product 1 is Liqui-Floc ™.

These results clearly show that chitosan is effective as a clarification aid in two very different types of slurries comprising water and mined solids.

Various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

What is claimed is:

1. A method of clarifying a slurry in a mining pond, wherein the slurry comprises water and mined solids, comprising
a) adding to the slurry from about 0.01 lbs chitosan/ton dry solids in the water in the pond to about 100 lbs chitosan/ton dry solids in the water in the pond,
b) allowing the chitosan to clarify the slurry with the result being that the mined solids are substantially separated from the water in the pond.

2. The method of claim 1 in which the mined solids comprise coal.

3. The method of claim 1 wherein an inert fluorescent tracer is added to the chitosan and one or more fluorometers are used to detect the fluorescent signal of the inert fluorescent tracer in the slurry in the pond, which fluorescent signal is used to determine how much inert fluorescent tracer is present and that information is used to determine how much chitosan is present and by knowing how much chitosan is present then if desired, adjustments to the operating conditions of the mining pond can be made to ensure the desired amount of chitosan is present.

4. The method of claim 3 in which the mined solids comprise coal.
